(19) United States
(12) Patent Application Publication
(10) Pub. No.: US 2015/0231561 A1
(43) Pub. Date: Aug. 20, 2015

(54) PROCESSES AND METHODS FOR LOW ENERGY CARBON DIOXIDE CAPTURE

(71) Applicant: Akermin, Inc., St. Louis, MO (US)

(72) Inventors: John Reardon, Lake St. Louis, MO (US); Alexander Shaffer, St. Louis, MO (US); Tracy Bucholz, St. Louis, MO (US); Aleksey Zaks, Hoboken, NJ (US)

(21) Appl. No.: 14/625,299

(22) Filed: Feb. 18, 2015

Related U.S. Application Data
(60) Provisional application No. 61/941,158, filed on Feb. 18, 2014.

(51) Int. Cl. B01D 53/84; B01D 53/62; B01D 53/96

(52) U.S. Cl. CPC B01D 53/84; B01D 53/96; B01D 53/62; B01D 2255/804; B01D 2257/504; B01D 2252/20494; B01D 2251/606

(57) ABSTRACT

The present invention generally relates to processes and methods for the capture of carbon dioxide from gases that are produced by various industrial processes including the capture of CO₂ from flue gases after the combustion of carbon-based fuels.

### CROSS-REFERENCE TO RELATED APPLICATIONS

This application claims the benefit of U.S. Provisional Application Ser. No. 61/941,158 which was filed Feb. 18, 2014. The entire content of this application is incorporated herein by reference.

### FIELD OF THE INVENTION

The present invention generally relates to processes and methods for the capture of carbon dioxide from gases that are produced by various industrial processes including the capture of CO₂ from flue gases after the combustion of carbon-based fuels.

### BACKGROUND OF THE INVENTION

Coal is the largest source of energy for the generation of electricity worldwide. World coal consumption is expected to increase to reach 9.05 billion tonnes by 2030. The flue gas generated by coal-fired power plants is the largest worldwide anthropogenic sources of carbon dioxide, and the capture and sequestration of carbon dioxide produced in the combustion of coal represents an important opportunity to reduce the electric grid's GHG footprint.

Similarly, the combustion of other carbon-based fuel sources, some of which are commonly touted as alternatives to coal, also contribute to GHG emissions. For example, during the period specified above, the combustion of natural gas contributed approximately 17% of the overall GHG emissions associated with the U.S. electric power grid. Flexible and cost effective technologies for the capture of CO₂ are needed. Suitable technologies should be adaptable to a variety of post-combustion sources at near atmospheric pressure that can contain as low as 4% CO₂ to as high as 16% CO₂, depending on plant efficiency, fuel source, and excess combustion air requirements.

Most efforts to develop competing technologies for post-combustion capture have been devoted to liquid solvents (advanced amines, potassium carbonate, mixtures of ionic liquids, etc.), solid adsorbents (supported amines, charcoal, metal organic frameworks, etc.) and membranes (amine-doped, biomimetic-based, etc.). Conceptual stage approaches include novel “tunable” solvents, hybrid capture systems, and novel regeneration approaches based on electrochemistry. Although significant research and development efforts have been devoted to post-combustion CO₂ capture in recent years, except for chemical amine and ammonia-based solvents, most approaches are still in the early stages of development. Moreover, key research questions remain concerning the technical viability of developmental stage technologies and the degree of improvement needed to be commercially viable.

Recently, some research and development initiatives have explored the use of aqueous solutions of non-volatile salts, such as potassium carbonate, as CO₂ capture agents that exhibit a lower heat of reaction relative to traditional primary amine and ammonia-based solvents. However, these alternative capture solutions suffer from two significant drawbacks in that the reaction kinetics are significantly slower than those of primary amine-based solutions, and in that the total specific heat duty (thermal regeneration energy input per mole of CO₂ captured) is not superior to conventional amine technology at typical regeneration pressures and temperatures. Several researchers have explored adding chemical additives such as piperazine or arsenate to accelerate absorption in potassium carbonate solutions, but in doing so the blended solution becomes less environmentally acceptable, more prone to oxidation breakdown, and increases the potential to emit hazardous air pollutants and volatile organic compounds—drawbacks that are commonly associated with traditional, high heat of reaction primary amine solvents. Generally, high heat-of-reaction solvents exhibit minimum regeneration energy at the highest practical regeneration temperature. Since higher temperature heat sources are more valuable to industrial operations, regeneration at high temperatures can negatively impact the cost of CO₂ capture. Conversely, low-heat-of-reaction solvents generally exhibit minimum regeneration energy at lower temperatures; however, regeneration performance may be limited by unfavorable reaction kinetics.

If a low heat of reaction solvent can utilize a lower value (e.g., lower temperature) heat source for solvent regeneration, the cost of CO₂ capture can be reduced. More particularly, it is desirable to provide a solvent and system that exhibits a low regeneration energy at relatively lower regeneration temperatures, while maintaining sufficiently favorable reaction kinetics and a suitable equilibrium.

Accordingly, an alternative absorption-regeneration process and solvent combination is needed that can meet the CO₂ removal requirements of industrial applications while effectively leveraging lower temperature heat sources for regeneration without compromising the reaction kinetics. A preferred solvent should also exhibit sufficient equilibrium, low volatility (to eliminate hazardous air pollutants and volatile organic carbon emissions), low environmental toxicity, high oxidative stability, and low corrosion potential.

### SUMMARY OF THE INVENTION

One of the various aspects of the invention is a process for removing CO₂ from a CO₂-containing gas, the process comprising contacting a liquid medium with a CO₂-containing gas in an absorption zone in the presence of a biocatalyst that promotes the absorption of CO₂ from the gas phase into the liquid medium, thereby producing a rich liquid medium; and introducing the rich liquid medium into a stripping zone operating under reduced pressure and comprising a biocatalyst that promotes the desorption of CO₂ from the liquid medium into the gas phase, thereby producing a lean liquid medium; wherein the temperature of the rich liquid medium exiting the absorption zone is within about 20° C. of the temperature of the lean liquid medium exiting the stripping zone.

Another aspect is a process for removing CO₂ from a CO₂-containing gas, the process comprising contacting a liquid medium with a CO₂-containing gas in an absorption zone in the presence of a biocatalyst comprising a carbonic anhydrase, thereby catalyzing hydration of the CO₂ and forming a rich liquid medium comprising a protonated base and bicarbonate ions; and contacting the rich liquid medium under reduced pressure with a biocatalyst comprising a carbonic anhydrase in a stripping zone, thereby catalyzing conversion of the bicarbonate ions into concentrated CO₂, water, and regenerated base to form a lean liquid medium; wherein the temperature of the rich liquid medium exiting the absorption zone is within about 20° C. of the temperature of the lean liquid medium exiting the stripping zone.

Other objects and features will be in part apparent and in part pointed out hereinafter.

### DESCRIPTION OF THE FIGURES

FIG. 1 depicts a simple block flow diagram of a steam power plant with a post-combustion CO₂ capture system.

FIG. 2 is a schematic of an exemplary CO₂ capture system as described herein. The flow sheet incorporates vacuum stripping and does not include the rich-lean cross-exchanger typical of conventional carbon capture processes. As described in detail below, the flow sheet is designed to accommodate a low heat of reaction solvent in combination with a biocatalyst that circulates throughout the absorber 103, stripper 105, and reboiler 107.

FIG. 3 is a schematic that illustrates how a CO₂ capture system as described herein could be integrated into a coal fired steam power plant.

FIG. 4 depicts the net steam turbine power output as a function of reboiler heat duty for different temperatures of bottom-tapped steam, where back pressure is adjusted to provide the desired steam temperature. Net turbine power output values were estimated based on 1693 tons/hr of total steam flow at the crossover pipe at 5.07 bara and 291.3° C., a steam turbine isentropic efficiency of 90%, and the parasitic power of a multi-stage vacuum blower having isentropic efficiency of 75% and a 2.1 maximum pressure ratio per stage.

FIGS. 5A and 5B depict the reboiler heat duty and the equivalent work (regeneration steam plus CO₂ compression), respectively, as functions of reboiler temperature in connection with various solvent and catalyst combinations.

FIG. 6 depicts estimated saturated steam-to-power efficiency as a function of reboiler temperature. The steam to power efficiency is approximated as 90% of ideal Carnot heat cycle efficiency, and the estimate assumes a cold reservoir temperature of 40° C. and a steam saturation temperature that is 10° C. above the reboiler temperature.

FIG. 7 depicts the equivalent work for various combinations of flow sheet and solvent options as applied to CO₂ capture and compression in a post combustion coal-fired flue gas application.

FIG. 8 illustrates the impact on incremental (increased) cost of electricity (ICOE) for a 550 MWe net coal power plant using various combinations of flow sheet and solvent options as applied to CO₂ capture and compression in a post combustion coal-fired flue gas application. As a reference, the cost of electricity generation without any CO₂ capture is estimated to be $58.8/MWh.

FIG. 9 illustrates the percentage of CO₂ captured from a gas stream as a function of total gas phase CO₂ loading in a continuous flow reactor, using either potassium carbonate (K₂CO₃) or 34% N,N-dimethylglycinate potassium salt (KDMG) as the capture solution. CO₂ capture data were also compared with and without the presence of a dissolved enzyme. All tests were performed in a 50 mL column packed with 3.66 mm ceramic spheres using 25 mL/min liquid and 400 sccm gas feed, 15% CO₂ in nitrogen and a pressure of 1.08 bara at room temperature.

FIG. 10 presents the enzyme-catalyzed acceleration of CO₂ capture (expressed as ratio of overall mass transfer coefficients K_{G catalyzed}/K_{G blank}) as a function of total gas phase CO₂ loading using either 20% w/w K₂CO₃ or 34% KDMG as the solvent.

FIG. 11 shows a scanning electron microscope image (7000× magnification) of a biocatalyst particle containing encapsulated carbonic anhydrase enzyme. The immobilization material is a silicate-polysilicone xerogel that was generated by spray drying sol-precursor materials containing a carbonic anhydrase enzyme. The particle cluster of this example is <10 microns and the primary grain size is submicron.

FIG. 12 depicts the rate enhancement factor in a batch (Parr) reactor, expressed as a ratio of the overall mass transfer coefficient (K_{G}) relative to a blank solution, as a function of the biocatalyst particle concentration using either 20% w/w K₂CO₃ or 34% KDMG as the solvent. The data were measured in a batch reactor with a gas stream containing 15% CO₂ in nitrogen.

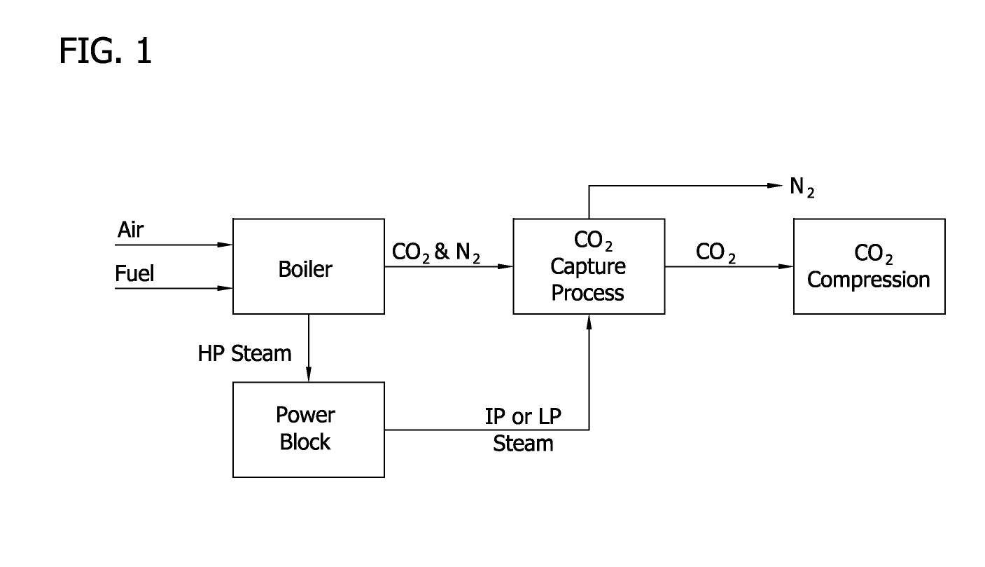

Corresponding reference characters indicate corresponding parts throughout the drawings.

### DESCRIPTION OF THE INVENTION

It has been discovered that the use of a low heat of reaction solvent for the absorption of CO₂, in an advanced process flow sheet enabled by one or more biocatalysts that promote both the hydration of CO₂ and the dehydration of bicarbonate, can enable the highly efficient removal of CO₂ from a flue gas stream with a significantly reduced parasitic power demand, thereby providing a significant reduction in cost of CO₂ capture. The combination of solvent, flow sheet, and biocatalyst as described herein provides a reduction in overall unit capital costs and a reduced cost of electricity for industrial processes that require CO₂ capture.

The processes and methods described herein provide for the use of lower temperature steam for CO₂ stripping (solvent regeneration) in an advanced process flow sheet that incorporates the biocatalyst delivery system described herein. Without the use of a biocatalyst delivery system as described herein, the use of low temperature steam would require very large stripping columns and/or significant reductions in the energy performance of the system. This reduction in stripping column size provides a substantial savings in the capital costs related to CO₂ capture.

The biocatalyst delivery system described herein also enables a significant reduction in the size of the absorption column, which also provides a substantial savings in capital costs related to CO₂ capture.

The processes and methods described herein further eliminate the need for some major pieces of equipment traditionally used in carbon capture operations. For example, a direct contact cooler or pre-scrubber; a cross exchanger; overhead wash; and a re-claimer may be eliminated. These reductions in equipment provide a significant savings in capital costs related to the carbon capture system.

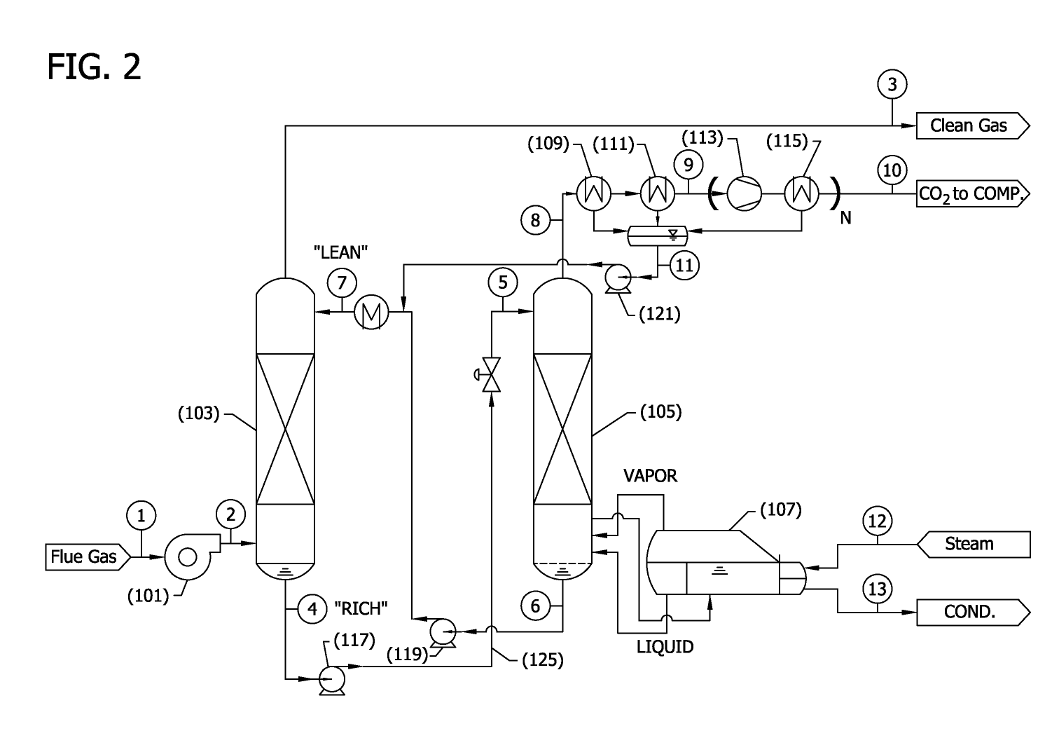

A general depiction of the novel CO₂ capture process described herein is shown in FIG. 2. An input flue gas stream 1, which is produced in the combustion of a generic carbon-based fuel source, is fed to the induced draft fan 101 and exits as gas stream 2, which is fed to the bottom portion of absorber 103.

A liquid medium comprising a solvent component that is “lean” in CO₂ enters the top portion of absorber 103 via stream 7. As the flue gas from stream 2 rises through the absorber and comes into contact with the liquid medium, CO₂ present in the gas stream is transferred into the liquid phase, forming a liquid medium that is “rich” in CO₂ and a clean gas 3.

As used herein, the term “rich” typically refers to the liquid medium having the highest CO₂ loading in the system. Typically, the highest CO₂ loading is present in the liquid stream exiting the bottom portion of the absorption column. More generally, the liquid stream exiting the absorption column may be referred to herein as “rich” in CO₂ until the point at which it enters the stripper.

As used herein, the term “lean” typically refers to the liquid medium having the lowest CO₂ loading in the system. Typically, the lowest CO₂ loading is present in the liquid stream entering the top portion of the absorption column. More generally, the portion of the liquid stream exiting the bottom portion of the stripper may be referred to herein as “lean” in CO₂ until the point at which it enters the absorber.

A person of skill in the art will understand that the actual value of the “rich” and “lean” CO₂ loadings will be determined based upon the particular application, and can vary widely based upon the specific operating conditions (e.g., mass flow rates) and other operational factors familiar to those skilled in the art.

As described in further detail below, the liquid medium present in absorber 103 also contains a biocatalyst that promotes the absorption of CO₂ from the gas phase into the liquid phase. As described in further detail below, this biocatalyst may be circulated throughout the system.

The “rich” liquid medium exits the bottom portion of the absorber 103 at stream 4. Stream 4 is subsequently transferred by pump 117 and through a back pressure valve to stream 5, which feeds the top portion of stripper 105. Notably, the rich liquid medium is transferred from the absorber 103 to the stripper 105 without encountering any thermally recuperative cross-exchanger.

As further detailed below, the reduced operating pressure of stripper 105 causes CO₂ to be released from the liquid into the gas phase. The reduced pressure also causes the liquid medium to boil at a reduced temperature.

The lean liquid medium is transported into reboiler 107, where it is indirectly heated by low-value steam at stream 12 and condensate stream 13 that exits the reboiler 107. Heating the lean liquid in reboiler 107 generates water vapor, which is returned to stripping column 105 in a sufficient quantity to drive the stripping process therein. A portion of the water vapor from reboiler 107 condenses inside the stripper 105, as it transfers the necessary heat of reaction and sensible duty required to drive the stripping reaction, and is returned to reboiler 107 along with the lean liquid medium. A second portion of the water vapor rises to the top of the stripping column, along with product CO₂, where it exits the top of the column at stream 8.

The lean liquid medium exiting reboiler 107 is returned into a reservoir at the bottom of the stripper 105, where it rests for a period of time (e.g., on the order of five to ten minutes), allowing for additional CO₂ release prior to exiting the stripper at stream 6. The lean liquid medium at stream 6 is then transferred by pump 119 and recycled to the top portion of the absorber 103 and optionally through condenser 123 via stream 7.

The lean liquid medium at stream 6 has a temperature that is very close to the liquid temperatures exiting the absorber at stream 4. Accordingly, the presence of a recuperative cross-exchanger is unnecessary in this system.

As described in further detail below, the liquid present in stripper 105 also contains a biocatalyst that promotes the dehydration of bicarbonate leading to the release of CO₂ from the liquid phase into the gas phase. As noted above, this biocatalyst is also present in absorber 103, and may be circulated throughout the absorber/stripper system.

In an alternative configuration, steam may be directly added to the stripper 105, in which case the reboiler 107 could be eliminated.

After the CO₂-rich gas stream 8 exits the top portion of stripper 105, it enters the overhead condenser heat exchanger 109, which utilizes conventional cooling water (e.g., at 25° to 30° C.) to drive the bulk of water vapor condensation and separation. Because stripper 105 operates at low pressure, it is desirable to minimize water vapor slip to the first or second stage of the multi-stage CO₂ compressor 111 to minimize vapor compression power requirements.

A polishing condenser heat exchanger 111 is optionally included so that a lesser amount of chilled water (e.g., 5° C.) or other sub-ambient cooling fluid can be used for gas dehydration to further minimize water vapor slip to the vapor compression system. Alternatively, other methods of moisture removal are well known in the art and could be included at 111 in lieu of a chilled heat exchanger (e.g., an enthalpy wheel or chemical absorption dryer).

The CO₂ exiting the process in stream 10 will be substantially pure (>99.9% pure CO₂ on dry basis), due to the selective nature of the biocatalyst enhanced capture agents described herein. Stream 10 may be provided at elevated pressure or discharged to near ambient pressure as required by the particular application. Typically, the product CO₂ at stream 10 would be further processed or dehydrated, utilized in an upgrading process, and/or piped to permanent geological sequestration using a variety of methods that are well known in the art.

Typically, water vapor that is condensed and removed from the gas stream in the overhead condenser 109, polishing condenser or dehydration unit 111, or intercooling stages 113, 115 of the multi-stage vapor compressor is subsequently collected and combined in a single liquid stream 11 that is reincorporated through pump 121 into the lean liquid medium stream 7 prior to its entry into absorber 103. This combined condensate stream may be optionally returned to the stripper 105 as reflux. However, since the CO₂ capture agents described herein are generally aqueous solutions of non-volatile salts, reflux in the stripper 105 is generally not required. Optionally, if water accumulates in the system, then condensate streams may be discharged from the process from stream 11.

### Absorption

The presence of a biocatalyst in the absorber enhances the rate of absorption of carbon dioxide into aqueous solution. The enhanced rate of absorption improves the selectivity of the solvent for CO₂ and increases the purity of CO₂ in the regeneration stream 10.

The temperature of the rich liquid stream exiting the bottom portion of the absorber (for example, stream 4 exiting absorption column 103 in FIG. 2) is from about 40° C. to about 75° C., from about 40° C. to about 65° C., from about 40° C. to about 60° C., or from about 45° C. to about 55° C.

The rich liquid exiting the bottom portion of the absorber may be within ±15° C., within ±10° C., or within ±5° C. of the lean liquid exiting the bottom portion of the stripper.

Additionally, due to improved kinetics provided by the presence of a biocatalyst, it is possible to operate the absorber at relatively low total pressures as compared to traditional CO₂ capture processes. For example, the absorber may be run at absolute pressures of from about 1 bar to about 5 bar, from about 1 bar to about 2 bar, from about 1 bar to about 1.5 bar, or from about 1 bar to about 1.2 bar.

The absorber may be run at a pressure that is not significantly higher than the feed gas supply pressure (e.g., the flue gas supply stream 1 of FIG. 2) to minimize the feed gas compression power requirements (e.g., the power requirements for compressor 101 of FIG. 2). For example, the absorber may be run at a pressure of no more than about 30 kPa (0.3 barg), no more than about 20 kPa (0.2 barg), or no more than about 10 kPa (0.1 barg) higher than the plant's gas supply pressure.

Alternatively, the absorber may be run at elevated pressures to accommodate higher pressure gas treatment applications. For example, the absolute pressure in the absorber may be greater than about 1 bar, greater than about 2 bar, greater than about 5 bar, greater than about 10 bar, greater than about 25 bar, or greater than about 50 bar. The absolute pressure in the absorber may be from about 1 bar to about 50 bar, from about 2 bar to about 50 bar, from about 5 bar to about 50 bar, from about 10 bar to about 50 bar, from about 1 bar to about 25 bar, from about 2 bar to about 25 bar, from about 5 bar to about 25 bar, or from about 10 bar to about 25 bar.

### Desorption (Stripper and Reboiler)

The presence of a biocatalyst in the CO₂ stripping column makes it possible to operate the regeneration system at relatively low temperatures as compared to traditional CO₂ capture processes. For example, the temperature of the lean liquid stream exiting the bottom portion of the stripper (e.g., stream 6 exiting stripper 105 in FIG. 2) is from about 45° C. to about 90° C., from about 45° C. to about 65° C., from about 50° C. to about 65° C., or from about 50° C. to about 60° C.

More specifically, it is desirable to operate the system such that there is a very small temperature difference between the absorber rich exit and the stripper lean exit streams (e.g., streams 4 and 6 of FIG. 2, respectively). In contrast to traditional CO₂ capture processes, the low temperature difference between the absorber and the stripper exit stream allows for the elimination of a recuperative cross exchanger, resulting in a significant capital savings.

For example, the temperature of the rich liquid medium exiting the absorber column may be within about 20° C. of the temperature of the lean liquid medium exiting the stripper column. The temperature of the rich liquid medium exiting the absorber may be within about 15° C., within about 10° C., or within about 5° C. of the temperature of the lean liquid exiting the stripper.

The temperature of the rich liquid medium exiting the bottom portion of the absorber (e.g., stream 4 of FIG. 2) may be higher or lower than the temperature of the lean liquid medium exiting the bottom portion of the stripper (e.g., stream 6 of FIG. 2). For example, the lean liquid medium exiting the bottom portion of the stripper is within about ±15° C., within about ±10° C., or within about ±5° C. of the rich liquid medium exiting the bottom portion of the absorber. For example, the temperature of the liquid medium exiting the absorption and stripping columns may be essentially equivalent.

The small difference in temperature between the liquid streams exiting the stripper and the absorber provides improved energy efficiency and enables the elimination of capital-intensive heat recuperation equipment typical of traditional CO₂ capture processes. Conventional CO₂ capture processes employ a substantial temperature swing to drive CO₂ regeneration, and therefore require heat recuperation equipment to achieve acceptable energy efficiency, whereas the process described herein employs little or no temperature swing.

Optionally, a portion of the liquid medium could pass through a cross-exchanger as it recirculates between the absorber and the stripper.

### Biocatalyst Recirculation

In addition to promoting the hydration of CO₂ to bicarbonate in the absorber, the biocatalyst also enhances the rate of dehydration of bicarbonate to release CO₂ in the stripper and reboiler. This acceleration of bicarbonate dehydration is particularly important at the lower temperatures proposed herein, otherwise at some point lower temperatures will result in unfavorably slow reaction rates in the reboiler and stripping column. In the absence of biocatalyst, the lower temperatures proposed herein would require an unfeasibly tall column to achieve the desired lean CO₂ loading. Moreover, an increase in stripping column height would add a significant pressure drop and increase the vacuum blower power and capital expense requirements.

For example, biocatalyst particles can be recirculated throughout the entire liquid loop (i.e., through piping and liquid reservoirs in the absorber column, stripper column, and reboiler) without requiring filtration or separation from the bulk liquid.

This flow scheme described herein stands in contrast to conventional CO₂ capture systems using elevated stripping temperatures (e.g., >100° C.), wherein the biocatalyst would need to be kept in the absorber and prevented from entering the stripper and reboiler to avoid thermal denaturing. While a biocatalyst particle might be separately employed to enhance absorption alone in a conventional flow scheme with inclusion of a higher temperature regeneration system (e.g., the stripper and reboiler), such segregated biocatalyst particle deployment requires filtration equipment to prevent excessive inactivation of the biocatalyst.

Without being bound to a particular theory, the relatively low and nearly equal temperature of the absorber and the stripper liquid effluents, as described above, allows the biocatalyst to be recirculated throughout the entire system with minimal thermal inactivation.

Moreover, the conventional solvent flow sheets used in industrial applications have stripper pressures at or slightly above local ambient pressure and, therefore, require stripping temperatures that are typically well above 100° C. While acceptable stripping reaction kinetics might be achieved without the use of a catalyst, high temperature solvent regeneration requires higher pressure steam, which is more valuable (for example, higher temperature steam can be used to make high value electric power in a power plant application, or can be used to drive high value distillation in a petroleum refinery application). Accordingly, while a biocatalyst might benefit absorption in the conventional process flow scheme, the use of a biocatalyst is neither necessary nor possible in a conventional, high temperature stripper and reboiler. As noted above, virtually all biocatalysts will become rapidly inactivated if allowed to circulate through a higher temperature regeneration system (e.g., the stripper and the reboiler).

In contrast, the processes and methods described herein utilize greatly reduced stripping temperatures to achieve a significant economic advantage in applications where low value heat sources can be utilized for regeneration. Meanwhile, lower reboiler and stripper temperatures enable the integration of biocatalysts that are permitted to circulate throughout the entire liquid system.

The processes described herein therefore embody a symbiotic relationship between the relatively low temperatures employed in the stripping column and the use of a biocatalyst that recirculates throughout the absorber/stripper system. The lower regeneration temperature used in the stripping column not only enables the use of a lower grade heat source, which results in a correspondingly lower cost of CO₂ capture, but also provides a thermally suitable environment for the biocatalyst.

As noted above, the biocatalyst may be present in the form of solid particles. When the biocatalyst is present in a particulate form, the spent biocatalyst can be recovered for disposal by using a slip stream filter system, and new catalyst added while the CO₂ capture system continues to operate. The flow sheet described herein therefore enables a simpler and lower cost method of catalyst replacement, as compared to conventional solutions such as a fully soluble catalyst (which cannot be separated from the capture solution) or an immobilized catalyst coating on solid packing (which is more labor intensive to replace).

### Pressure

In addition, and as described in further detail below, the liquid medium that recirculates through the absorber and the stripper comprises one or more solvents having a low heat of reaction for the absorption of CO₂. Generally, a low heat of reaction solvent may be defined as a solvent wherein the molar heat of CO₂ absorption is less than or approximately equal to the heat of vaporization of water. Advantageously, desorption of CO₂ and regeneration of these solvents can be achieved under vacuum (i.e., low pressure) conditions without a substantial increase in specific energy requirements (e.g., kJ thermal/kg CO₂). A low heat of reaction solvent may also be characterized by a specific regeneration energy that does not substantially increase with decreasing stripping pressures. This stands in contrast to high heat of reaction solvents (e.g., traditional solvents based on primary and secondary amines that have molar heats of absorption that are greater than the molar heat of vaporization of water), which are more favorably regenerated at high temperatures to minimize the specific energy requirements and as such require steam with higher energy.

The reboiler may be run at low absolute pressures (i.e., an absolute pressure less than about 1 bar). For example, the absolute pressure in the reboiler may be less than about 1 bar, less than about 0.8 bar, less than about 0.6 bar, less than about 0.5 bar, less than about 0.4 bar, less than about 0.3 bar, or less than about 0.2 bar. The absolute pressure in the reboiler may be from about 0.01 bar to about 0.7 bar, from about 0.05 bar to about 0.35 bar, or from about 0.1 bar to about 0.25 bar. Generally, the pressure in the bottom portion of the stripper is equivalent to the pressure in the reboiler.

Besides the advantages described above, a lower pressure in the reboiler (i.e., the stripper bottom pressure) also provides a lower boiling temperature for the liquid medium. By lowering the required boiling temperature, the conditions inside the reboiler become thermally compatible with the presence of a biocatalyst, allowing the biocatalyst to fully circulate throughout the entire liquid system.

### Liquid Medium

The liquid medium comprises an aqueous mixture of one or more non-volatile CO₂ capture agents (i.e., proton accepting bases) that have a low heat of reaction for the overall CO₂ hydration reaction. The term “low heat of reaction”, as used herein, refers to a molar heat of CO₂ absorption that is less than the molar heat of vaporization of water (for example, at the stripper liquid inlet temperature). A “non-volatile” capture agent, as used herein, refers to a proton accepting base formulation that has near zero vapor pressure in the absorber.

The liquid medium may comprise an inorganic salt of carbonate (CO₃⁼). For example, the liquid medium may comprise potassium carbonate (K₂CO₃). The use of potassium carbonate as a solvent for CO₂ absorption is well known in the art, and it provides a lower heat of reaction compared to more traditional primary and secondary amine solvents (e.g., monoethanolamine).

The liquid medium may also comprise one or more amino acid salts, for example N-monosubstituted or N,N-disubstituted amino acid salts, which do not react significantly with unhydrated CO₂. The liquid medium may contain N-disubstituted (tertiary) amino-acid salts which have low heats of reaction, and/or it may contain sterically hindered N-monosubstituted amino acids salts with low heats of reaction.

Non-limiting examples of amino acid salts suitable for use with the processes described herein include salts of alanine, arginine, asparagine, asparagine, aspartic acid, cysteine, glutamic acid, glutamine, glycine, histidine, isoleucine, leucine, lysine, methionine, phenylalanine, proline, serine, threonine, tryptophan, tyrosine, valine, and mono- and di-substituted derivatives thereof.

The amino acid may be present in the form of an alkali metal salt thereof. For example, the amino acid may be activated with potassium hydroxide or other alkali hydroxide (e.g., lithium hydroxide or sodium hydroxide), which results in the amino acid salt.

Generally, the liquid medium may comprise a primary, secondary, or tertiary amino acid salt. Tertiary amino acid salts (i.e., di-substituted), in particular, exhibit favorable energetic properties with regard to both the absorption and desorption of CO₂.

For example, the liquid medium can comprise potassium salt of N,N-dimethylglycine.

The amino acid may be present as a salt where the cation will result in the greatest solubility of the amino acid salt and its CO₂ loaded product. For example, the amino acid may be present as the sodium or potassium salt thereof (e.g., the potassium salt of N,N-dimethylglycine).

The liquid medium may contain additives to enhance the life-time of the biocatalyst. The liquid medium may also contain additives to reduce the solubility of inhibitory heavy metal compounds.

### Biocatalyst Function

In the processes and methods described herein, a biocatalyst is used to promote both the hydration of CO₂ in the absorber (CO₂ capture) and the dehydration of bicarbonate (CO₂ release) in the stripper.

Generally, the catalyst may be an enzyme, a ribozyme, a deoxyribozyme, an enzyme mimic, or an organic or inorganic bio-mimetic compound that can catalyze the hydration of carbon dioxide and/or the dehydration of bicarbonate.

The same biocatalyst may be used to promote both CO₂ absorption and bicarbonate decomposition.

Alternatively, a first biocatalyst may be used to promote CO₂ absorption and a second, different biocatalyst can be used to promote the decomposition of bicarbonate in the stripper.

### Biocatalyst Delivery

In the processes and methods described herein, the biocatalyst may be immersed within the liquid medium and carried by the liquid medium as it recirculates throughout the absorption and stripping processes.

The biocatalyst may be uniformly distributed throughout the bulk of the liquid medium. The properties and design of the biocatalyst micro-particle, including the density and degree of surface hydrophobicity, may be selected to provide for such uniform dispersion.

Alternatively, the biocatalyst may spend a disproportionate amount of time at the gas-liquid interface as compared to being immersed deeper within the bulk liquid medium. The properties and design of the biocatalyst micro-particle, including the density and degree of surface hydrophobicity, may be selected to provide for a disproportionate surface concentration.

In these processes and methods, the use of a biocatalyst micro-particle (for example, active carbonic anhydrase enzymes that are entrapped within a micro-particulate supporting structure) provides a number of advantages as compared to the use of a biocatalyst that is directly dissolved within the liquid medium (e.g., a soluble enzyme). For example, soluble enzymes are known to inactivate easily under high shear conditions presented by high pressure pumps, high velocity flow through pipes, flow over high gas-liquid surface area packed columns, flow through gas sparged contactors, and especially locations with rapid degassing and boiling that are typical of the solvent regeneration system (e.g., in the stripper and reboiler). Moreover, denatured enzymes can contribute to foaming upsets and a range of significant process-related issues throughout the absorber, stripper, and reboiler. Since the denaturing is typically accelerated under degassing conditions, a soluble enzyme delivery will result in untenable operational issues.

To address these issues, the biocatalyst may be immobilized by entrapment within a solid particulate material.

For example, the biocatalyst may be delivered in the liquid medium as a plurality of nano-particles or micro-particles. Each biocatalyst particle may be comprised of a protective structure that encapsulates the biocatalyst, but also provides for un-hindered diffusion of CO₂ and bicarbonate ions into and out of the areas of the particle that contain the active catalyst.

The active biocatalyst particles may form a free-flowing suspension in the liquid medium, which recirculates continuously through the absorption/stripping cycle.

The formulation and synthesis of active biocatalyst particles is generally known in the art. (see, for example, R. Aines, LLNL-PRESS-499751).

For example, the biocatalyst may be incorporated into a colloidal particulate micron-size or sub-micron-size xerogel powder. (See, for example, Pierre, A. C., Biocatalysis and Biotransformation (2004) vol. 22(3), p. 145-170.) Xerogel powders provide a number of advantageous properties (e.g., high surface areas, high porosity, and small pore diameters), and have the potential to improve biocatalyst proximity to the gas-liquid interface while minimizing diffusional limitations.

Typically, the sol-gel process for creating enzyme-containing xerogel particles begins with a solution containing the biocatalyst, alkoxysilane monomers, and any additives and solvents necessary for the given formulation. Upon addition to an aqueous solution, and usually with the aid of a polymerization catalyst, the monomer molecules begin to hydrolyze and form bonds with other monomer molecules, eventually forming a colloidal suspension of micro-particles (a “sol”). The condensation of the sol into a gel phase results in the biocatalyst being entrapped within the polymeric matrix, forming stabilizing pores in the material. As polymerization proceeds and solvent is evaporated, a gel is condensed, and later becomes a dried silicate material containing the encapsulated biocatalyst.

For example, the xerogel particles can be formed by spray-drying the material into a fine powder in heated air, by drying the bulk gel and mechanically grinding and sieving to an appropriate particle size, by forming the gel in a non-solvent via a micro-emulsion process, by CO₂ supercritical drying, or by any other means known in the art.

For example, the biocatalyst may comprise a xerogel particle derived from a sol comprising (i) an alkoxy silane or an organotrialkoxy silane or metasilicate, (ii) a poly(silicone), and (iii) a biocatalyst. The biocatalyst xerogel particle typically has a particle size range of 100 nm to less than 10 μm or more than 20 μm to 250 μm.

The size of the primary particles, the pore diameter, the size of the agglomerated clusters, and the surface charge are expected to affect the performance of the biocatalyst particles in liquid suspension. As a result, control of these features during production is desirable, and as such a reproducible production method is typically employed.

As an alternative, at least a portion of the biocatalyst may be immobilized by entrapment within a coating (e.g., a xerogel coating) on a solid support. Coated supports comprising immobilized biocatalytic enzymes are described, for example, in U.S. patent application Ser. No. 13/840,696, the entire contents of which are incorporated herein by reference.

For example, the coated support may comprise a polysilicate-polysilicone copolymer immobilizing a biocatalyst, wherein the polysilicate-polysilicone copolymer is adhered to a solid support by an adhesive coating.

The adhesive coating typically comprises a polymer adhesive. For example, the polymer adhesive may comprise a urethane polymer, an epoxy polymer, a resin, a cyanoacrylate polymer, a methacrylate polymer, or a combination thereof.

Typically, the coating composition is derived from reaction of a sol and a catalyst.

For example, the biocatalyst may be an immobilized enzyme comprising an enzyme and an immobilization material, wherein the enzyme is entrapped within the immobilization material and the immobilization material is derived from reaction of a sol and a catalyst, the sol comprising (i) an alkoxy silane or an organotrialkoxy silane or metasilicate, (ii) a poly(silicone), and (iii) an enzyme. Typically, the poly(silicone) comprises a poly(siloxane).

The solid support may be a commercially available packing material or structured packing material. For example, the solid support may be a commercially available random packing material.

Particularly, the solid support comprises a ceramic material (e.g., the solid support may be a ceramic sphere). Alternatively, the solid support comprises stainless steel.

Generally, when the biocatalyst is immobilized by entrapment within a coating (e.g., a xerogel coating), the coating material may have an overall pore volume, surface area, and/or average pore size as described above.

The coating may comprise one or more layers of the coating, wherein a biocatalyst is immobilized by entrapment within each layer of the coating.

When the biocatalyst is immobilized (e.g., in a xerogel particle as described above, or in a xerogel coating adhered to a solid support), the coating or immobilization material typically has an overall pore volume of at least about 3 μL/g to 500 μL/g.

The coating or immobilization material may have a surface area of at least about 1 m²/g, at least about 5 m²/g, at least about 10 m²/g, at least about 20 m²/g, at least about 30 m²/g, at least about 40 m²/g, at least about 50 m²/g, at least about 60 m²/g, at least about 70 m²/g, at least about 80 m²/g, at least about 90 m²/g, at least about 100 m²/g, at least about 150 m²/g, at least about 200 m²/g, or at least about 300 m²/g.

For example, the coating or immobilization material typically has a surface area of from about 1 m²/g to about 400 m²/g, from about 5 m²/g to about 300 m²/g, from about 10 to about 150 m²/g, or from about 15 to about 100 m²/g.

Further, the immobilization material can be in the form of particles having a surface area of from about 100 m²/g to about 400 m²/g.

The coating or immobilization material may also have an average pore size of from about 2 nm to about 80 nm.

### Biocatalyst

As described in detail above, the biocatalyst may comprise enzyme catalysts that are incorporated into a particle delivery system.

Alternatively, the biocatalyst may include known organic catalysts, inorganic catalysts, or bio-mimetic catalysts that are incorporated into a particle delivery system.

When the biocatalyst comprises an enzyme, naturally-occurring enzymes, man-made enzymes, artificial enzymes and modified naturally-occurring enzymes can be utilized. In addition, engineered enzymes that have been engineered by natural or directed evolution can be used. Also, an organic or inorganic molecules that mimics an enzyme's properties can be used.

### Carbonic Anhydrase

One example of a biocatalyst is carbonic anhydrase. Carbonic anhydrase accelerates CO₂ hydration by catalyzing de-protonation of water, shuttling the proton away from the active site, and converting CO₂ at the active site to bicarbonate ion with a characteristic reaction time of approximately 10⁻⁶ seconds. The reversible dehydration of bicarbonate is also catalyzed by carbonic anhydrase, as shown below.

$${CO}_{2} + {H}_{2} O {↔}^{ CA } {HCO}_{3}^{-} + {H}^{+} \qquad [ 1 ]$$

Without being bound by theory, it is believed that a carbonic anhydrase enzyme catalyzes hydration of carbon dioxide by having a zinc atom in the active site that coordinates to three histidine side chains while having the fourth coordination position of the zinc atom occupied by water. The coordination of the water by the zinc atom causes polarization of the hydrogen-oxygen bond. A fourth histidine accepts a proton from the coordinated water molecule resulting in a hydroxide attached to the zinc atom. The carbonic anhydrase active site also contains a pocket for carbon dioxide that brings it close to the hydroxide group and allows the electron-rich hydroxide to attack the carbon dioxide to form bicarbonate. In this way, the carbonic anhydrase is involved in the hydration of carbon dioxide. (Tripp, B. C., Smith, K., & Ferry, J. G. (2001). Carbonic Anhydrase: New Insights for an Ancient Enzyme. Journal of Biological Chemistry, 276 (52), 48615-48618.)

Generally, the term carbonic anhydrase (“CA”) represents a family of structurally and genetically diverse enzymes that arose independently from different precursors as a result of convergent evolution (Tripp, B. C., Smith, K., & Ferry, J. G. (2001). Carbonic Anhydrase: New Insights for an Ancient Enzyme. Journal of Biological Chemistry, 276 (52), 48615-48618; Elluche, S., & Pöggeler, S. (2010). Carbonic Anhydrases in Fungi. Microbiology, 156, 23-29). The various CA enzymes have been organized into five unrelated structural classes (e.g., alpha, beta, gamma, delta, and epsilon) which share no DNA sequence similarity and differ in protein structure and active site architecture. Despite these structural differences, the active sites of all classes of CA enzymes function with a single divalent metal cofactor which is essential for catalysis (Tripp, B. C., Smith, K., & Ferry, J. G. (2001). Carbonic Anhydrase: New Insights for an Ancient Enzyme. Journal of Biological Chemistry, 276 (52), 48615-48618). The most common metal cofactor in CA enzymes is zinc.

The α-class of CA is the predominant form expressed in mammals, and is the best characterized of all the CA classes. There are at least 16 α-CA or CA-related enzymes (Supuran, C. T. (2008). Carbonic Anhydrases—An Overview. Current Pharmaceutical Design, 14, 603-614 found in animals, as well as six forms found in bacteria. The β-class of CAs are found in green plants, blue-green algae, and bacteria (Zimmerman, S. A., & Ferry, J. G. (2008). The β and γ Classes of Carbonic Anhydrases. Current Pharmaceutical Design, 14, 716-721) (Rowlett, R. S. (2010). Structure and Catalytic Mechanism of the β-Carbonic Anhydrases. Biochimica et Biophysica Acta, 1804, 362-373). The γ-class is found in bacteria and an example would be the CA from Methanosarcina thermophila (CAM) (Zimmerman, S. A., & Ferry, J. G. (2008). The β and γ Classes of Carbonic Anhydrases. Current Pharmaceutical Design, 14, 716-721). The CAM gene has been cloned into E. coli and is expressed as the Zn-containing form (Alber, B. E., & Ferry, J. G. (1996). Characterization of Heterologously Produced Carbonic Anhydrase from Methanosarcina thermophila. Journal of Bacteriology (June), 3270-3274), but it is more active as the Fe-, Cd-, or Co-form. The δ-class can be found in the marine diatom Thalassiosira weissflogii (Zimmerman, S. A., & Ferry, J. G. (2008). The β and γ Classes of Carbonic Anhydrases. Current Pharmaceutical Design, 14, 716-721). This example protein is a dimer, with a monomeric molecular weight of 27 kD. The protein will bind Zn-, but Fe- and/or Cd-predominates in vivo. Likewise, the ζ-class is also found in the marine diatom Thalassiosira weissflogii (Zimmerman, S. A., & Ferry, J. G. (2008). The β and γ Classes of Carbonic Anhydrases. Current Pharmaceutical Design, 14, 716-721). The protein is also a dimer with a molecular weight of 50-60 kD. The catalytic properties of these two classes have not been characterized.

The mammalian CA enzymes are divided into four broad subgroups depending on the tissue or cellular compartment location (e.g., cytosolic, mitochondrial, secreted, and membrane-associated). The CAII and CAIV enzymes are the most catalytically efficient of all the CAs characterized, demonstrating rates of catalysis that are near the theoretical limit for diffusion-controlled rates. CA IV demonstrates particularly high temperature stability, which is believed to result from the presence of two disulfide linkages in the enzyme.

Mammalian carbonic anhydrase, plant carbonic anhydrase, or microbial carbonic anhydrase; preferably, bovine carbonic anhydrase II or human carbonic anhydrase IV is used. Human carbonic anhydrase IV is available from William S. Sly at St. Louis University and is described in more detail in the following references: T. Okuyama, S Sato, X. L. Zhu, A. Waheed, and W. S. Sly, Human carbonic anhydrase IV: cDNA cloning, sequence comparison, and expression in COS cell membranes, Proc. Natl. Acad. Sci. USA 1992, 89(4), 1315-1319 and T. Stams, S. K. Nair, T. Okuyama, A. Waheed, W. S. Sly, D. W. Christianson, Crystal structure of the secretory form of membrane-associated human carbonic anhydrase IV at 2.8-Å resolution, Proc. Natl. Acad. Sci. USA 1996, 93, 13589-13594.

Compounds that mimic the active site of carbonic anhydrase can also be used. For example, various metal complexes have been used to mimic the carbonic anhydrase active site. For example, [Zn₂(3,6,9,12,20,23,26,29-octaazatricyclo[29.3.1.1^{14,18}]hexatriaconta-1(34), 14,16,18(36),31(35),32-hexaene)(CO₃)]Br₂.7H₂O and [Zn₂(3,6,9,12,20,23,26,29-octaazatricyclo[29.3.1.1^{14,18}]hexatriaconta-1(34), 14,16,18(36),31(35),32-hexaene)(CO₃)]Br₂.0.5CH₃COCH₃.5H₂O (See Qi et al., Inorganic Chemistry Communications 2008, 11, 929-934). Also used as a mimic for carbonic anhydrase was [tris(2-benzimidazolylmethyl)amineZn(OH)₂]²⁺, [tris(2-benzimidazolyl)amineZn(OH)₂](ClO₄)₂, and [tris(hydroxy-2-benzimidazolylmethyl)amineZn(OH)]ClO₄.1.5H₂O were also used to hydrate CO₂. (See Nakata et al., The Chemistry Letters, 1997, 991-992 and Echizen et al., Journal of Inorganic Biochemistry 2004, 98, 1347-1360).

For example, the carbonic anhydrase may be an alpha-carbonic anhydrase, a beta-carbonic anhydrase, a gamma-carbonic anhydrase, a delta-carbonic anhydrase, or an epsilon-carbonic anhydrase. Typically, the carbonic anhydrase is an alpha-carbonic anhydrase and further is a cytosolic carbonic anhydrase, a mitochondrial carbonic anhydrase, a secreted carbonic anhydrase, or a membrane-associated carbonic anhydrase.

More typically, the carbonic anhydrase is a mammalian carbonic anhydrase, a plant carbonic anhydrase, or a microbial carbonic anhydrase. Most typically, the carbonic anhydrase is a microbial carbonic anhydrase.

Having described the invention in detail, it will be apparent that modifications and variations are possible without departing from the scope of the invention defined in the appended claims.

### EXAMPLES

The following non-limiting examples are provided to further illustrate the present invention.

### Example 1

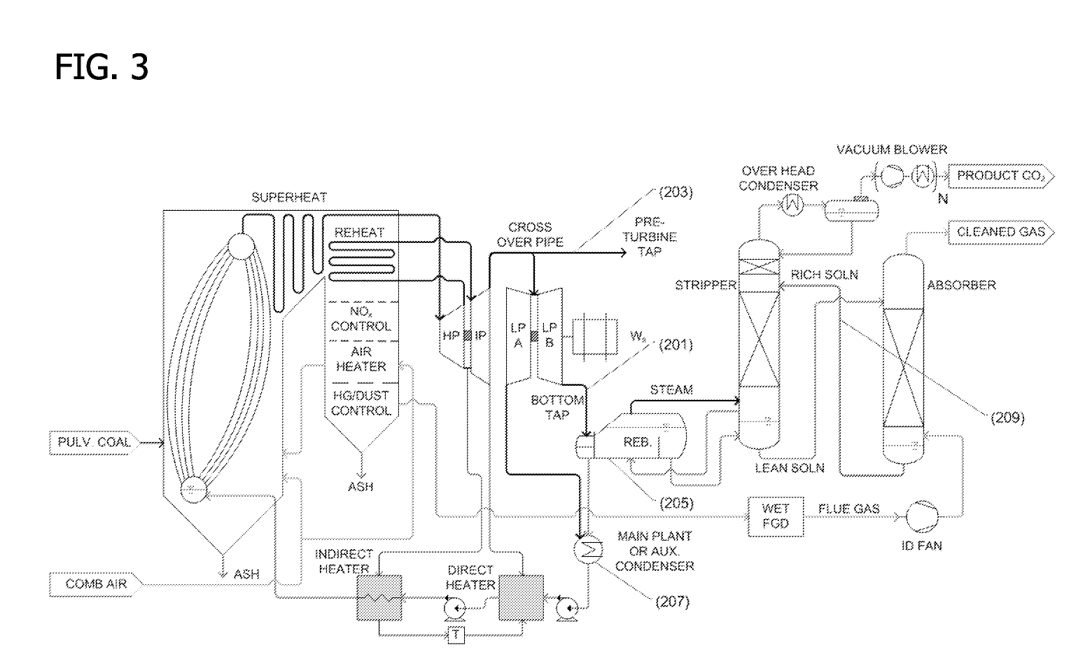

Preliminary modeling was conducted for a CO₂ capture process corresponding to the flow sheet depicted in FIG. 2 integrated into a coal combustion, supercritical steam, power plant as shown in FIG. 3, and as described in detail above.

Generally, FIG. 3 illustrates how a CO₂ capture system as described herein might be integrated into a coal fired steam power plant. Unique features of the integration are disclosed to minimize parasitic power and minimize capital cost in a retrofit application where regeneration steam is collected at 201 entirely from the bottom of one side of the low-pressure steam turbine doublet—in contrast to the conventional split of steam flow at the inlet of the low pressure turbine 203. The figure shows the main plant condenser 207 located immediately after the reboiler 205 to aid in drafting low pressure steam through the reboiler steam tubes. As an alternative, a separate condenser could have been located in close proximity to the reboiler. Additionally, the rich solution from the bottom of the absorber is transferred through line 209 to the top of the stripper.

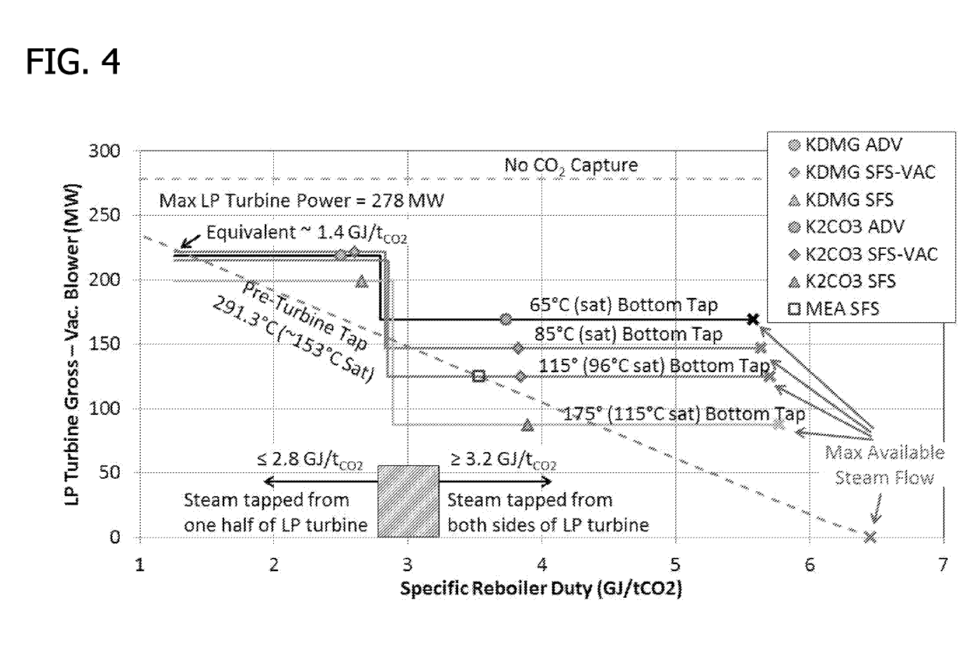

FIG. 4 illustrates the increased power generation potential that can be realized by collecting steam from the bottom of the low pressure steam turbine over collecting steam from the inlet of the low pressure steam turbine of a power plant with CO₂ capture. This figure reveals an upper threshold of ˜2.8 GJ/t CO₂ where only one side of the bottom tapped steam turbine is needed to supply all of the heat needed for solvent regeneration in a coal flue gas power application. Under these conditions, the bottom tap steam option provides greater power output compared to pre-turbine steam tap unless the reboiler heat duty is less than 1.4 GJ/t CO₂—a performance that is unmatched in a post combustion flue gas application by any high heat of reaction solvent system. The bottom tap option may be desirable in a retrofit application when an intermediate extraction point is not available in the existing turbine, or if intermediate extraction would be too expensive, or if the flow requirement was too high to support an intermediate extraction point.

The process model used in this example assumed a reboiler pressure of 0.14 bara, corresponding to 55° C. lean liquid temperate at stripper exit point 6. The lean liquid was subsequently cooled to 40° C. (at process point 7) before feeding to the absorber 103. The performance of the flow sheet as described above was modeled with two different CO₂ capture agents. In the first system of this example the liquid medium comprised a 20% w/w aqueous solution of K₂CO₃. In the second system of this example, the liquid medium was a 34% w/w solution of N,N-dimethylglycinate potassium salt (KDMG). In both systems, immobilized carbonic anhydrase biocatalyst, present as a micro-particle suspension in the liquid medium, was modeled using recirculation throughout the absorber/stripper liquid loop.

Mass and energy balance data from the preliminary process modeling, conducted for the K₂CO₃ system, are set forth in Table 1 below. Similarly, mass and energy balance data from the model KDMG system are set forth in Table 2 below.

TABLE 1
Process model estimates for 20 wt. % K₂CO₃ solution, 90% CO₂ capture,
683 MWe gross, 550 MWe net Power.

| | | Process Point: | | | | | | |
|---|---|---|---|---|---|---|---|---|
| | | 1 | 2 | 3 | 4 | 5 | 6 | 7 |
| | | Stream Notes: | | | | | | |
| | | Flue | Flue | Clean | Rich | Rich | Lean | Lean |
| | | Gas | Gas | Gas | Soln | Soln | Soln | Feed |
| Mass Flow | kg/sec | 738 | 738 | 558 | 5,653 | 5,653 | 5,368 | 5,472 |
| Volume Flow | m³/sec | 692 | 675 | 515 | 4.81 | 55 | 4.57 | 4.65 |
| Density | kg/m³ | 1.07 | 1.10 | 1.08 | 1,176 | 103.33 | 1,174 | 1,178 |
| Mol Weight | kg/kmol | 28.87 | 28.87 | 27.85 | 21.40 | 21.38 | 20.97 | 20.91 |
| Temperature | ° C. | 56.9 | 61.8 | 40.6 | 51.8 | 51.1 | 55.0 | 40.0 |
| Pressure | bara | 1.013 | 1.055 | 1.013 | 1.04 | 0.25 | 0.141 | 1.20 |
| Mass Frac | WET | 20.6% | 20.6% | 2.7% | | | | |
| CO₂ | | | | | | | | |
| Mol Frac CO₂ | DRY | 15.9% | 15.9% | 1.9% | | | | |
| Mol Frac H₂O | WET | 15.0% | 15.0% | 6.9% | | | | |
| CO₂ Loading | mol/ | | | | 0.350 | 0.334 | 0.150 | 0.150 |
| | mol K⁺ | | | | | | | |
| Enthalpy | kJ/kg | | | | | | | |

| | | Process Point: | | | | | |
|---|---|---|---|---|---|---|---|
| | | 8 | 9 | 10 | 11 | 12 | 13 |
| | | Stream Notes: | | | | | |
| | | Wet | Wet | Wet | Still | | |
| | | CO₂ | CO₂ | CO₂ | Cond. | Steam | Cond. |
| Mass Flow | kg/sec | 286 | 147 | 138 | 139 | 220 | 220 |
| Volume Flow | m³/sec | 2594 | 999 | 45 | 0.138 | 1255 | 0.224 |
| Density | kg/m³ | 0.11 | 0.15 | 3.02 | 999.9 | 0.18 | 981.9 |
| Mol Weight | kg/kmol | 25.15 | 40.26 | 43.57 | 18.02 | 18.02 | 18.02 |
| Temperature | ° C. | 44.3 | 10.0 | 10.0 | 10.0 | 65.0 | 65.0 |
| Pressure | bara | 0.115 | 0.086 | 1.60 | 0.086 | 0.250 | 0.250 |
| Mass Frac | WET | 48.0% | 93.5% | 99.3% | | 0.0% | 0.0% |
| CO₂ | | | | | | | |
| Mol Frac CO₂ | DRY | 100% | 100% | 100% | | 0.0% | 0.0% |
| Mol Frac H₂O | WET | 72.5% | 14.4% | 1.7% | | 100.0% | 100.0% |
| CO₂ Loading | mol/ | | | | | | |
| | mol K⁺ | | | | | | |
| Enthalpy | kJ/kg | | | | | 2618.3 | 272.1 |

TABLE 2
Process model estimates for 34% KDMG solution, 90% CO₂ captured,
673 MWe gross, 550 MWe net Power.

| | | Process Point: | | | | | | |
|---|---|---|---|---|---|---|---|---|
| | | 1 | 2 | 3 | 4 | 5 | 6 | 7 |
| | | Stream Notes: | | | | | | |
| | | Flue | Flue | Clean | Rich | Rich | Lean | Lean |
| | | Gas | Gas | Gas | Soln | Soln | Soln | Feed |
| Mass Flow | kg/sec | 724 | 724 | 574 | 3010 | 3010 | 2765 | 2876 |
| Volume Flow | m³/sec | 677 | 658 | 531 | 2.52 | 28.7 | 2.32 | 2.41 |
| Density | kg/m³ | 1.07 | 1.10 | 1.08 | 1,196 | 105 | 1,194 | 1,194 |
| Mol Weight | kg/kmol | 28.87 | 28.87 | 27.85 | 25.85 | 25.85 | 25.16 | 25.16 |
| Temperature | ° C. | 56.9 | 61.8 | 40.6 | 60.8 | 60.0 | 55.0 | 40.0 |
| Pressure | bara | 1.013 | 1.055 | 1.013 | 1.04 | 0.25 | 0.141 | 1.20 |
| Mass Frac | WET | 20.6% | 20.6% | 2.7% | | | | |
| CO₂ | | | | | | | | |
| Mol Frac CO₂ | DRY | 15.9% | 15.9% | 1.9% | | | | |
| Mol Frac H₂O | WET | 15.0% | 15.0% | 6.9% | | | | |
| CO₂ Loading | mol/ | | | | 0.698 | 0.690 | 0.250 | 0.250 |
| | mol K⁺ | | | | | | | |
| Enthalpy | kJ/kg | | | | | | | |

| | | Process Point: | | | | | |
|---|---|---|---|---|---|---|---|
| | | 8 | 9 | 10 | 11 | 12 | 13 |
| | | Stream Notes: | | | | | |
| | | Wet | Wet | Wet | Still | | |
| | | CO₂ | CO₂ | CO₂ | Cond. | Steam | Cond. |
| Mass Flow | kg/sec | 245 | 142 | 134 | 111 | 142 | 142 |
| Volume Flow | m³/sec | 2500 | 947 | 44 | 0.111 | 789 | 0.145 |
| Density | kg/m³ | 0.098 | 0.15 | 3.02 | 999.9 | 0.18 | 981.9 |
| Mol Weight | kg/kmol | 20.51 | 40.26 | 43.57 | 18.02 | 18.02 | 18.02 |
| Temperature | ° C. | 42.9 | 10.0 | 10.0 | 10.0 | 65.0 | 65.0 |
| Pressure | bara | 0.115 | 0.086 | 1.60 | 0.086 | 0.250 | 0.250 |
| Mass Frac | WET | 54.8% | 93.5% | 99.3% | | 0.0% | 0.0% |
| CO₂ | | | | | | | |
| Mol Frac CO₂ | DRY | 100% | 100% | 100% | | 0.0% | 0.0% |
| Mol Frac H₂O | WET | 67.3% | 14.4% | 1.7% | | 100.0% | 100.0% |
| CO₂ Loading | mol/ | | | | | | |
| | mol K⁺ | | | | | | |
| Enthalpy | kJ/kg | | | | | 2618.3 | 272.1 |

Properties of the K₂CO₃ and KDMG systems are set forth in Table 3 below.

TABLE 3
Property Data for 20% K₂CO₃ and 34% KDMG embodiments

| | | Projected | Projected |
|---|---|---|---|
| | Units | Performance | Performance |
| Pure Solution | | 20 wt. % K₂CO₃ | 34 wt. % KDMG |
| Molecular Weight (Salt) | g/mol | 138.2 | 141.2 |
| Normal Boiling Point (Soln.) | ° C. | 104 | 108 |
| Normal Freezing Point (Soln.) | ° C. | −4 | −9 |
| Vapor Pressure @ 15° C. | bar | Non-volatile salt | Non-volatile salt |
| Working Solution | | 20 eq. wt % K₂CO₃ | 34 eq. wt % KDMG |
| Concentration (mass frac.) | kg/kg soln | 0.20 | 0.34 |
| Specific Gravity (15° C.) | — | 1.19 | 1.21 |
| Specific Heat @ STP | kJ/kg-K | 3.5 | 3.0 |
| Surface Tension @ STP | dyn/cm | ~78 | ~58 |
| Absorption | | | |
| Pressure | bar | 1.07 | 1.07 |
| Solution Viscosity | cP | 0.98 | 1.9 |
| Desorption | | | |
| Pressure (Reboiler) | bar | 0.14 | 0.14 |
| Lean Exit Temperature | ° C. | 55 | 55 |

A listing of estimated auxiliary electrical loads is presented in

Table, along with relevant scale information. The preliminary modeling reveals an approximate 43% reduction in total plant auxiliary loads using the flow sheet of this invention with 34% KDGM as compared to the DOE Case-12 baseline. Additionally, there was a ˜14% reduction in the total amount of CO₂ produced due to improved energy efficiency, which occurs because the power plant is smaller for the same net power output.

More particularly, Table 4 presents the captured CO₂ flow rate assuming 90% removal of CO₂ and 550 MWe net power production. The proposed capture solutions (20% K₂CO₃ and 34% KDMG) are more thermodynamically efficient and, therefore, less coal is burned, leading to less generated CO₂. Lower temperature steam extraction results in less coal burned, enabling a smaller and lower cost boiler, smaller SO₂ scrubber, and smaller CO₂ capture unit. Likewise, the CO₂ compressor duty is lower for the same reasons.

TABLE 4
Summary of Heat Duty, Equivalent Work, and CO₂ capture rate

| | Reference | | |
|---|---|---|---|
| | Case-12, Rev 1 | 20% K₂CO₃ | 34% KDMG |
| Thermal Regeneration Energy (GJ/t CO₂) | 3.56 | 3.76 | 2.50 |
| CO₂ Feed to Absorber (t CO₂/hr) | 609.4 | 547.6 | 531.8 |
| (Scaled to 550 MWe net) | | | |
| CO₂ Captured (t CO₂/hr) | 548.5 | 492.9 | 478.7 |
| Steam Rate (kg/kg CO₂) | 1.23 | 1.60 | 1.07 |
| Steam Temperature (° C.) | 185.0 | 65.0 | 65.0 |
| Steam to Power Efficiency | 28.5% | 6.65% | 6.65% |
| Steam Equiv. Work (MW) | 154.4 | 34.2 | 22.7 |
| Pump and Fan Power for CO₂ Capture (MW) | 20.6 | 12.5 | 8.0 |
| Auxiliary Power, Vacuum Compression | 0.0 | 37.0 | 34.3 |
| to 1.6 bara (MW) | | | |
| Auxiliary Power for Larger Boiler (MW) | 16.9 | 10.9 | 9.6 |
| CO₂ Compression 1.6 to 155 bara (MW) | 44.9 | 40.3 | 39.1 |
| Total Plant Auxiliary Loads (MW) | 236.9 | 134.9 | 113.7 |

The auxiliary loads in Table 4 were divided by the CO₂ capture flow to provide the equivalent work per unit of CO₂ captured (kWh/t CO₂), which is presented in Table 5 below.

TABLE 5
Unit CO₂ basis accounting of auxiliary loads for CO₂ capture and
compression.

| | Reference | | |
|---|---|---|---|
| | Case-12, | | 34% |
| | Rev 1 | 20% K₂CO₃ | KDMG |
| Parasitic Power, per unit CO₂ | (kWh/t CO₂) | (kWh/t CO₂) | (kWh/t CO₂) |
| Steam Regeneration Impact | 281.5 | 69.5 | 46.2 |
| Aux. Power for CO₂ Capture | 37.6 | 25.3 | 17.2 |
| Vacuum Blower | 0.0 | 75.1 | 75.5 |
| Compression 1.6 to 155 Bara | 81.8 | 81.8 | 81.8 |
| Sub-Total: Aux. Power for | 400.9 | 251.6 | 220.7 |
| CCS | | | |
| Aux. Power for Larger Boiler | 30.9 | 22.3 | 20.3 |
| Total Plan Auxiliary Load | 431.8 | 273.9 | 241.0 |
| (kWh/t CO₂) | | | |
| Total without aux load for | 400.9 | 251.6 | 220.7 |
| boiler | | | |

The data presented in Table 5 indicate that a coal power plant incorporating the CO₂ capture process disclosed herein, utilizing a biocatalyst and a 34% KDMG solvent, would have a parasitic impact of less than 221-kWh/t CO₂.

In the analysis set forth above, the vacuum compression power is reported for collecting CO₂ from the specified vacuum and compressing to 1.6 bar (absolute pressure) using a 4-stage intercooled blower with 75% isentropic efficiency. The compression of CO₂ from 1.6 to 155 bar (absolute pressure) was estimated for a 7-stage intercooled unit with 85% isentropic efficiency with chilled inter-stage cooling to 10° C. The estimated chiller work adds 14 kWh/t CO₂ to the equivalent work reported in Table 5.

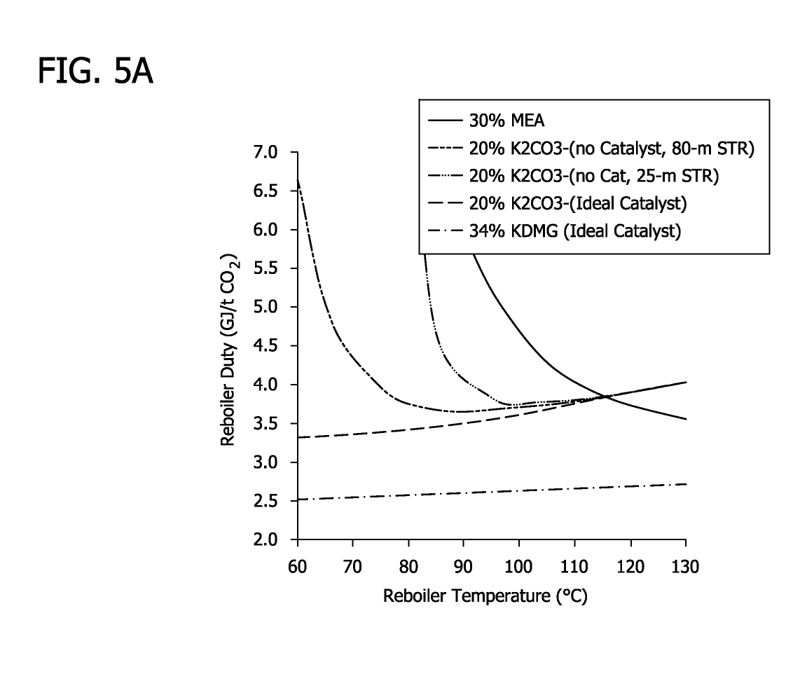

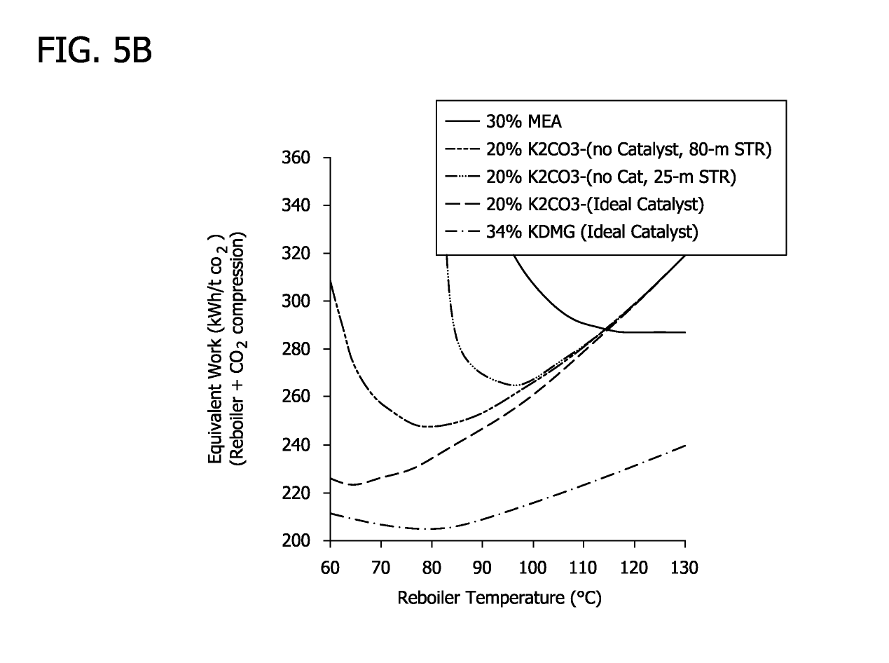

FIGS. 5A and 5B depict the estimates of reboiler heat duty and the equivalent work (regeneration steam plus CO₂ compression), respectively, as functions of reboiler temperature, for monoethanolamine (a high heat of reaction solvent) and potassium carbonate. The data show that traditional high heat of reaction solvents, such as MEA, are not efficiently regenerated at low temperatures and require a greater energy input than either potassium carbonate or KDMG, which have more favorable regeneration energy potentials at lower temperature. More particularly, the equivalent work (for steam plus CO₂ compression) for the low-heat-of-reaction solvent will be significantly better than the high heat of reaction system even for the same reboiler heat duty (˜290 kWh/t CO₂ for MEA at 125° C. compared to ˜250 kWh/t CO₂ for catalyzed K₂CO₃ at 90° C.). The net power generation potential of a low pressure steam turbine is plotted in FIG. 5 as a function of the specific regeneration steam demand, expressed as reboiler heat duty (GJ/t CO₂). The net power output is adjusted for steam temperature and vacuum blower power requirements (where applicable).

### Example 2

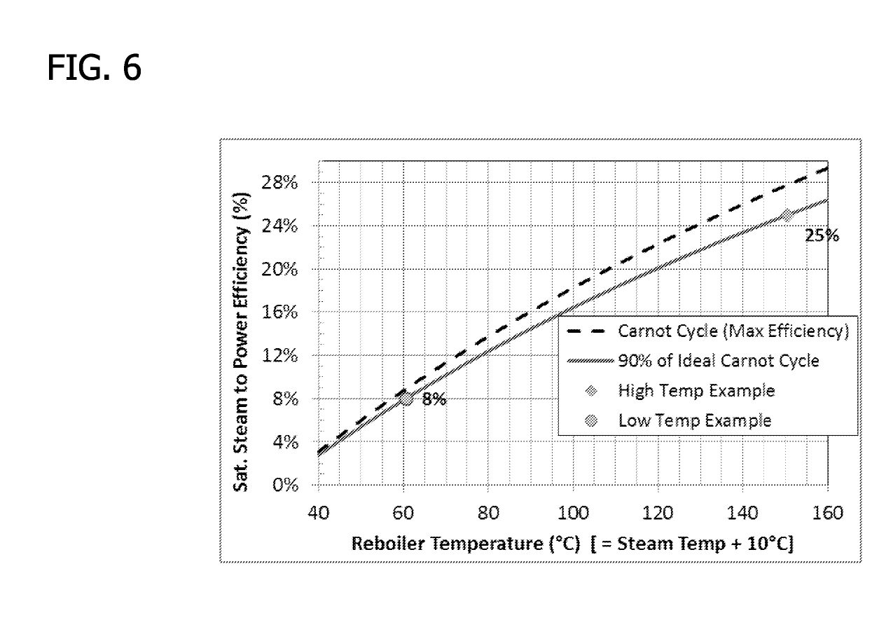

The model data presented in FIG. 6 illustrate the significant changes in saturated steam-to-power efficiency as a function of reboiler temperature. The data markers on the plot illustrate potential for 70% reduction in parasitic power for a 60° C. reboiler (70° C. steam) compared to a 150° C. reboiler (160° C. steam), for the same reboiler heat duty. Moreover, to the extent that reboiler heat duty can also be lowered considering a preferred solvent selection, as in this invention, then the parasitic power will be further reduced. The steam to power efficiency is approximated by 90% of ideal Carnot heat cycle efficiency, assumes a minimum reference temperature of 40° C. (313 K), and assumes a steam saturation temperature that is 10° C. above the reboiler temperature.

### Example 3

Process modeling and cost estimation for CO₂ capture from flue gas generated by a supercritical steam, pulverized coal, power plant was performed to evaluate the benefits of the advanced process flow sheet disclosed herein with 20% w/w K₂CO₃ and 34% w/w KDMG compared to 30% w/w MEA. To separate the roles of solvent and flow sheet in reducing equivalent work the corresponding cost of CO₂ capture, the energy and cost performances were compared to the use of a conventional flow sheet with ambient pressure regeneration and with catalyst present only in the absorber, a conventional flow sheet with vacuum stripping and catalyst present only in the absorber, and the advanced flow sheet disclosed in FIG. 2 and described in detail above, which features a biocatalyst circulating throughout the entire liquid solvent loop.

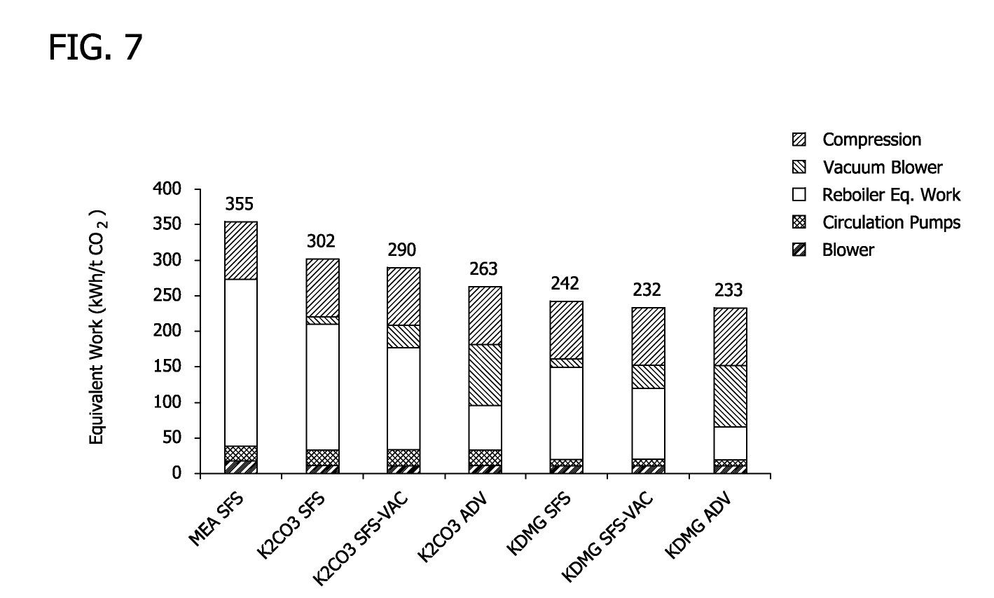

FIG. 7 presents the equivalent work that resulted from detailed energy balance modeling of various process flow sheets and solvents cases defined in the list below. The lowest equivalent work case resulted from the KDMG solvent in the advanced flow sheet (ADV) of this invention (233 kWh/t CO₂). Each of the test cases depicted in FIG. 7 is described below in Table 6.

TABLE 6
Reference and test cases evaluated for energy efficiency of CO₂ capture and
compression

| | |
|---|---|
| MEA SFS | 30% MEA in the conventional solvent flow sheet (SFS) with regeneration at 1.6 |
| | bara, 40° C. lean feed to the absorber, and other details as specified in the NETL- |
| | case 12, revision 2. |
| K₂CO₃ SFS | 20% potassium carbonate aqueous solution in the conventional solvent flow |
| | sheet (SFS) with catalyst only in the absorber and regeneration at 1 bar; 40° C. |
| | lean feed to the absorber, lean CO₂ loading 0.30 and rich loading 0.70 mol/mol |
| | K₂CO₃; 5° C. minimum approach temperature in cross exchanger; regeneration |
| | steam extracted at 10° C. above the reboiler temperature; and compression inter- |
| | stage cooling to 30° C. |
| K₂CO₃ SFS- | 20% potassium carbonate aqueous solution in the conventional solvent flow |
| VAC | sheet (SFS) with catalyst only in the absorber and regeneration at 0.5 bar; 40° C. |
| | lean feed to the absorber, lean CO₂ loading 0.30 and rich loading 0.70 mol/mol |
| | K₂CO₃; 5° C. minimum approach temperature in cross exchanger; regeneration |
| | steam extracted at 10° C. above the reboiler temperature; and compression inter- |
| | stage cooling to 30° C. |
| K₂CO₃ ADV | 20% potassium carbonate aqueous solution in the Advanced flow sheet (ADV) |
| | of this invention enabled with biocatalyst circulating throughout the system and |
| | regeneration at 0.15 bar; lean CO₂ loading 0.30 and rich loading 0.70 mol/mol |
| | K₂CO₃; 55° C. absorber rich liquid exit temperature, 55° C. stripper lean liquid exit |
| | temperature with no-cross exchanger; regeneration steam extracted at 10° C. |
| | above the reboiler temperature; and compression inter-stage cooling to 30° C. |
| KDMG SFS | 34% KDMG aqueous solution in the conventional solvent flow sheet (SFS) with |
| | catalyst only in the absorber and regeneration at 1 bar; 40° C. lean feed to the |
| | absorber, lean CO₂ loading 0.30 and rich loading 0.70 mol/mol KDMG; 5° C. |
| | minimum approach temperature in cross exchanger; regeneration steam extracted |
| | at 10° C. above the reboiler temperature; and compression inter-stage cooling to |
| | 30° C. |
| KDMG SFS- | 34% KDMG aqueous solution in the conventional solvent flow sheet (SFS) with |
| VAC | catalyst only in the absorber and regeneration at 0.5 bar; 40° C. lean feed to the |
| | absorber, lean CO₂ loading 0.30 and rich loading 0.70 mol/mol K₂CO₃; 5° C. |
| | minimum approach temperature in cross exchanger; regeneration steam extracted |
| | at 10° C. above the reboiler temperature; and compression inter-stage cooling to |
| | 30° C. |
| KDMG ADV | 34% KDMG aqueous solution in the Advanced flow sheet (ADV) of this |
| | invention enabled with biocatalyst circulating throughout the system and |
| | regeneration at 0.15 bar; lean CO₂ loading 0.30 and rich loading 0.70 mol/mol |
| | K₂CO₃; 55° C. absorber rich liquid exit temperature, 55° C. stripper lean liquid exit |
| | temperature with no-cross exchanger; regeneration steam extracted at 10° C. |
| | above the reboiler temperature; and compression inter-stage cooling to 30° C. |

While the K₂CO₃ solvent reduces equivalent work in the conventional flow sheet, its performance is significantly improved with the advanced flow sheet. Furthermore, while the (KDMG) solvent provides reduced equivalent work relative to K₂CO₃ in the conventional flow sheet, the combination of advanced flow sheet with preferred solvent yields the lowest overall equivalent work. As such, the combination of advanced process and preferred solvent and the enabling by biocatalyst will also give the lowest cost of electricity as will be described below.

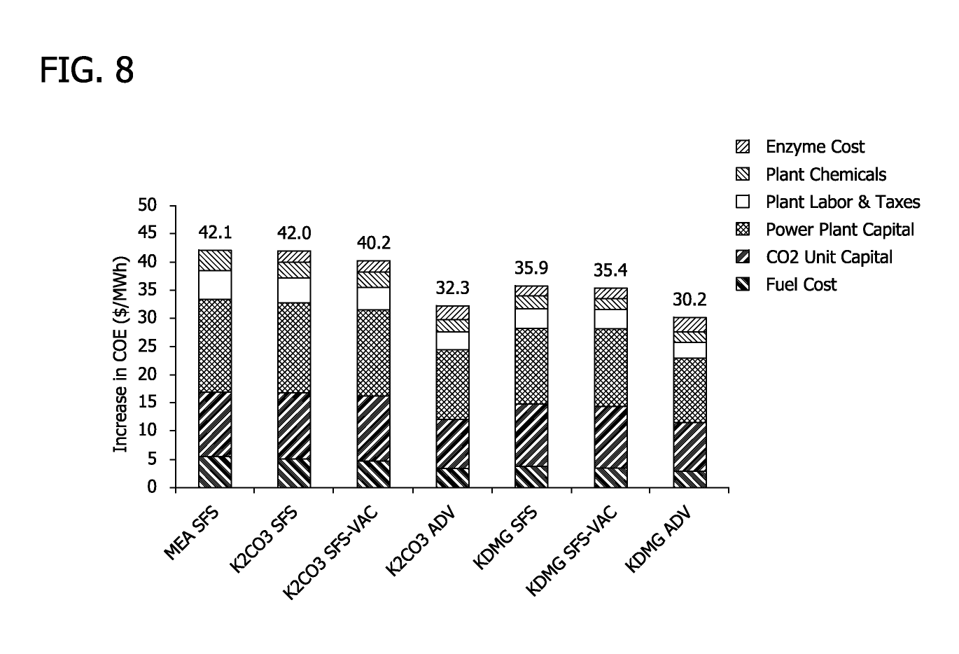

FIG. 8 presents contributions to increased cost of electricity (ICOE) for the power plant with CO₂ capture based on detailed cost estimation of the various process flow sheets and solvents cases defined previously with equivalent work detailed in FIG. 7. The lowest incremental cost of electricity was $35/MWh, achieved with the KDMG solvent in the advanced flow sheet (ADV) of this invention.

Table 7 below sets forth the cost of electricity, the CO₂ emissions, the CO₂ captured, the cost of CO2 captured, and the cost of CO₂ avoided for the NETL Case-12 and the best case (KDMG ADV) presented above in FIG. 8—which indicates potential to achieve $40/t CO₂ captured.

TABLE 7
Cost of Electricity, Cost of Capture, and Cost of Avoided CO₂ for this
invention with KDMG (34% KDMG) compared to reference
(NETL Case-12, rev 2)

| | NETL-12 R2 | Flow sheet |
|---|---|---|
| | (30% MEA) | (KDMG) |
| Cost of Electricity (COE) with CO₂ capture | 106.5 | 93.8 |
| ($/MWh) | | |
| Cost of Electricity (COE) with No | 58.8 | 58.8 |
| Capture ($/MWh) | | |
| CO₂ Emitted, No Capture Case (t/hr) | 441.2 | 441.2 |
| CO₂ Emitted, w/Capture (t/hr) | 61.0 | 53.2 |
| CO₂ Captured (t/hr) | 548.7 | 478.7 |
| Net Power Output (MWh) | 550.0 | 550.0 |
| Cost of CO₂ Capture | 47.8 | 40.3 |
| Cost of CO₂ Avoided | 69.0 | 49.7 |
| Reduction in Cost of Capture | 0.0% | 15.8% |
| Reduction in Avoided Cost of CO₂ | 0.0% | 28.0% |

### Example 4

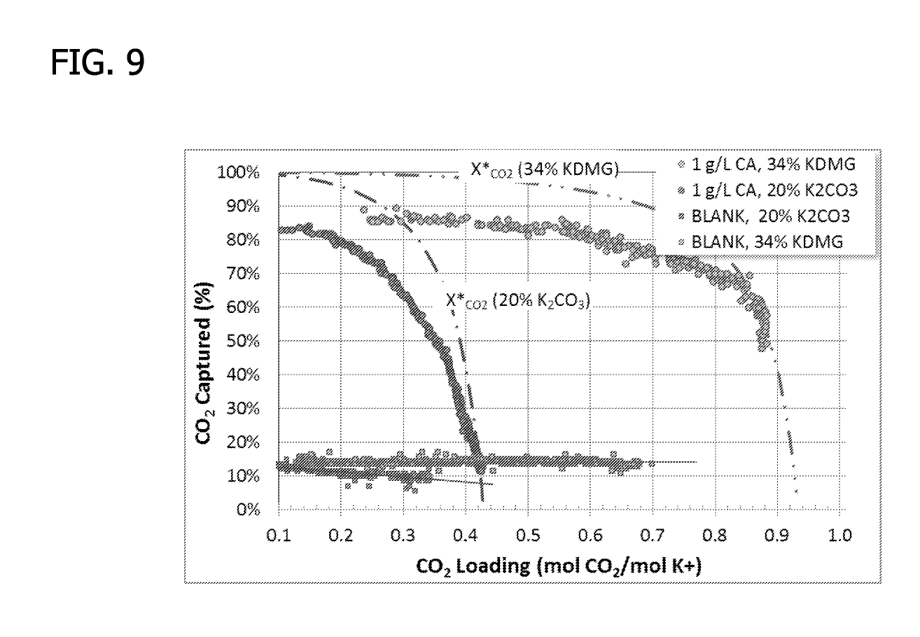

FIG. 9 presents CO₂ capture data collected in a counter flow Single Pass Reactor (SPR) column at 23° C. as a function of CO₂ loading for 20% K₂CO₃ (blue data markers) and 34% KDMG solution (green data markers). Blank (un-catalyzed) data-squares and enzyme catalyzed data-circles are presented. Carbonic anhydrase from NOVOZYMES (NS81239) was used (as total protein in mixture) in soluble form at 1 g/L. A pH assay method was used to continuously monitor the CO₂ loading in the column. The equilibrium CO₂ capture, X*, was calculated from equilibrium partial pressure data correlations available via PROTREAT™. All tests were performed in a 50 mL column packed with 3.66 mm ceramic spheres using 25 mL/min liquid and 400 sccm gas feed, 15% CO₂ in nitrogen and 1.08 bara (absolute pressure) at room temperature.

The data presented in FIG. 9 clearly illustrate a significant enhancement in the CO₂ capture in both K₂CO₃ and KDMG in the presence of the catalyst. Moreover, the data demonstrate a major improvement in equilibrium rich loading in KDMG compared to K₂CO₃. A maximum rich loading of only approximately 0.42 mol/mol K⁺ is achieved in the K₂CO₃ system at room temperature whereas KDMG is approaching the equilibrium rich loading of approximately 0.9 mol/mol K⁺. Moreover, the KDMG system can be used at higher concentrations with reduced risk of bicarbonate precipitation; therefore, the circulation rates become competitive with the best primary amine solvents contributing to reduced column diameters, smaller pumps, lower pumping costs, and lower regeneration energies.

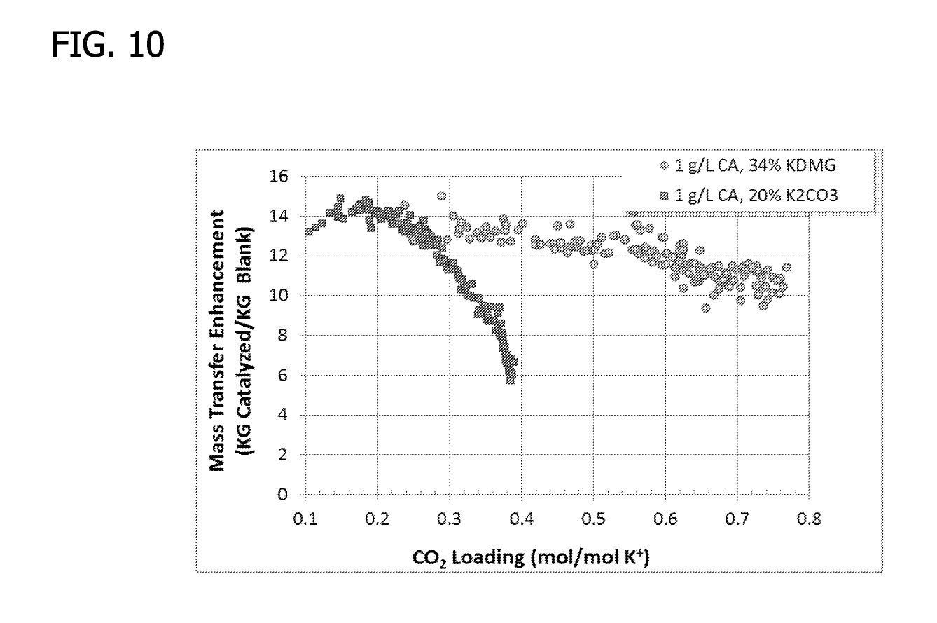

The data in FIG. 9 as used to calculate the ratio of overall mass transfer coefficients relative to the control (un-catalyzed) and plotted in FIG. 10. The 12 to 15-fold increase in K_{G} was observed in the presence of 1 g of total protein per liter solution, a portion of which is active carbonic anhydrase. The data illustrate that KDMG can be enhanced with the same enzymes that were previously shown to enhance K₂CO₃ solutions. Moreover, the data show that high enhancement is achieved over a broader range of CO₂ loading in the KDMG solvent.

### Example 5

To ascertain whether KDMG supports long-term performance of the NOVOZYMES carbonic anhydrase (CA) enzyme, two developmental samples of recombinant CAs were incubated in a 34 wt. % solution of KDMG (pH 10.7 at 55° C.). Periodically, their activity was determined by measuring the CO₂ capture rate in a batch reactor.

It was observed that the NOVOZYMES CA retained more than 80% activity after 24 hours incubation at 55° C. The data indicate quite clearly that the KDMG system described herein is compatible with carbonic anhydrases.

It should be noted that the above experiments were performed with a soluble enzyme. It is well documented, however, that a protein immobilized inside a confined space is significantly stabilized, and the stabilizing effect is influenced by the size and shape of the pore containing the enzyme protein. It is therefore expected that the long-term performance of a NOVOZYMES CA that has been immobilized as described herein (e.g., entrapped in silica xerogel microparticles) in either K₂CO₃ or a KDMG solvent will be suitable for use in the processes and methods described herein.

### Example 6

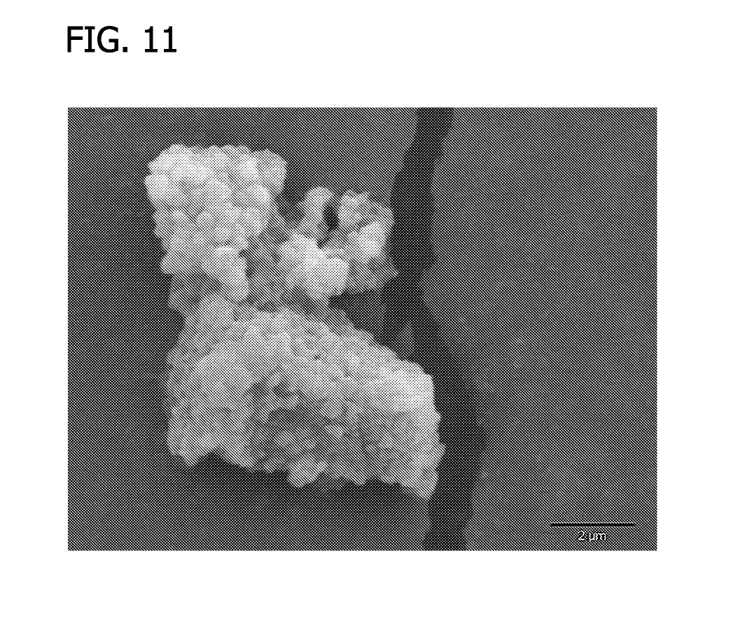

FIG. 11 is a scanning electron microscope image (7000× magnification) of a xerogel particle containing entrapped carbonic anhydrase enzyme. The immobilization material is a silicate-polysilicone xerogel that is generated by spray drying sol-precursor materials containing the carbonic anhydrase enzyme.

As seen in the image, the grain size of the primary particles appears to be on the order of 0.1 micrometers, which is significant to reducing intra-particle diffusional resistances. Meanwhile, the agglomerated clusters have been produced in the range of 2 to 5 microns in diameter and the agglomerated cluster of primary grains results in a relatively open structure—the combination of these features minimizes inter-particle transport resistances. The small primary grains and open pore structure allow the clusters to maintain a high surface area, while minimizing external mass transfer resistance (due to inter-particle dimensions). While the key feature of this invention is to accommodate biocatalyst particles without bulk filtration, the cluster size is sufficient to enable filtration for catalyst performance maintenance via slip stream processing.

### Example 7

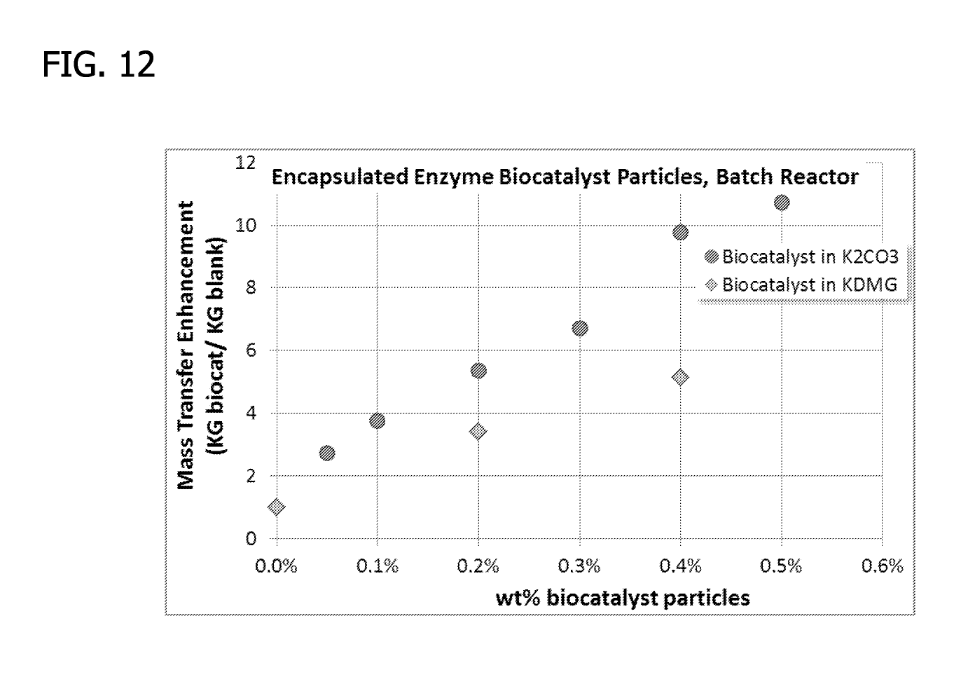

FIG. 12 shows that high enhancement can be achieved with the enzyme encapsulated in a biocatalyst particle system with a relatively small amount of solid biocatalyst. Here again, the multiplier or overall enhancement factor is expressed as a ratio of the overall mass transfer coefficient, K_{G}, relative to blank solutions. The data showed that overall mass transfer coefficients could be enhanced by 5 to 10 fold using less than 0.4% w/w biocatalyst particles. In this case the data was measured in a batch reactor with 15% CO₂ in nitrogen.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there can be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

1. A process for removing CO₂ from a CO₂-containing gas, the process comprising:
contacting a liquid medium with a CO₂-containing gas in an absorption zone in the presence of a biocatalyst that promotes the absorption of CO₂ from the gas phase into the liquid medium, thereby producing a rich liquid medium; and
introducing the rich liquid medium into a stripping zone operating under reduced pressure and comprising a biocatalyst that promotes the desorption of CO₂ from the liquid medium into the gas phase, thereby producing a lean liquid medium;
wherein the temperature of the rich liquid medium exiting the absorption zone is within about 20° C. of the temperature of the lean liquid medium exiting the stripping zone.

2. The process of claim 1 wherein the biocatalyst comprises an enzyme.

3. The process of claim 1 wherein the biocatalyst comprises a carbonic anhydrase.

4. A process for removing CO₂ from a CO₂-containing gas, the process comprising:
contacting a liquid medium with a CO₂-containing gas in an absorption zone in the presence of a biocatalyst comprising a carbonic anhydrase, thereby catalyzing hydration of the CO₂ and forming a rich liquid medium comprising a protonated base and bicarbonate ions; and
contacting the rich liquid medium under reduced pressure with a biocatalyst comprising a carbonic anhydrase in a stripping zone, thereby catalyzing conversion of the bicarbonate ions into concentrated CO₂, water, and regenerated base to form a lean liquid medium;
wherein the temperature of the rich liquid medium exiting the absorption zone is within about 20° C. of the temperature of the lean liquid medium exiting the stripping zone.

5. The process of claim 4 wherein the temperature of the rich liquid exiting the absorption zone is within about 10° C. of the temperature of the lean liquid exiting the stripping zone.

6. The process of claim 4 wherein the reaction temperature of the rich liquid exiting the absorption zone is within about 5° C. of the temperature of the lean liquid exiting the stripping zone.

7. (canceled)

8. The process of claim 4 wherein at least a portion of the liquid medium is continuously recirculated through the absorption zone and the stripping zone and wherein said continuous recirculation occurs in the absence of a cross-exchanger between the absorption zone and the stripping zone.

9. The process of claim 8 wherein the temperature of the rich liquid medium exiting the absorption zone is from about 40° C. to about 60° C.

10. (canceled)

11. The process of claim 9 wherein the absorption zone is operated at ambient atmospheric pressure.

12. (canceled)

13. The process of claim 9 wherein the temperature of the lean liquid medium exiting the stripping zone is from about 50° C. to about 60° C.

14. (canceled)

15. The process of claim 11 wherein the absolute pressure within the stripping zone is from about 0.1 bar to about 0.25 bar.

16.-17. (canceled)

18. The process of claim 4 wherein the liquid medium comprises potassium carbonate.

19.-20. (canceled)

21. The process of claim 4 wherein the liquid medium comprises N,N-dimethylglycine, or a salt thereof.

22.-23. (canceled)

24. The process of claim 4 wherein the biocatalyst promotes both the absorption of CO₂ in the absorption zone the desorption of CO₂ in the stripping zone.

25. The process of claim 24 wherein at least a portion of the biocatalyst is continuously recirculated through the absorption zone and the stripping zone.

26. The process of claim 24 wherein at least a portion of the biocatalyst is immobilized by entrapment within a solid particulate material.

27. The process of claim 26 wherein the liquid medium comprises a plurality of microparticles, wherein each microparticle encapsulates an active CO₂ hydration catalyst.

28. The process of claim 27 wherein the microparticles form a free-flowing suspension in the liquid medium, which recirculates continuously through the absorption zone and the stripping zone.

29. The process of claim 28 wherein the biocatalyst is incorporated into a micron-size xerogel powder.

30.-33. (canceled)

34. The process of claim 29 wherein the xerogel powder has a surface area of from about 100 to about 400 m²/g.

35. (canceled)
